(19) United States
(12) Patent Application Publication
(10) Pub. No.: US 2006/0175737 A1
(43) Pub. Date: Aug. 10, 2006

(54) Blow mold

(76) Inventors: Shawn Overmyer, Fremont, CA (US); Martin Cass, Port Clinton, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/349,798

(22) Filed: Feb. 8, 2006

Related U.S. Application Data
(60) Provisional application No. 60/650,808, filed on Feb. 8, 2005.

(51) Int. Cl. B29C 49/00

(52) U.S. Cl. 264/523; 425/522

(57) ABSTRACT

The mold includes a first mold block having a first contact surface and a first shear surface, a second mold block having a second contact surface and an insert seating surface, and at least one removable insert having a second shear surface and positionable along the insert seating surface. The first mold block is separable from and engageable with the second mold block between open and closed positions of the mold. The mold is moved between open and closed positions by the movement of at least one of the mold blocks along a path of travel. When the mold is moved from an open to a closed position, the first shear surface and the second shear surface form an interference fit.

### CROSS-REFERENCE TO RELATED APPLICATIONS

This non-provisional application claims the benefit of U.S. Provisional Patent Application No. 60/650,808, entitled “Blow Mold,” filed Feb. 8, 2005.

### FIELD OF THE INVENTION

The present invention relates to mold processing equipment and more particularly to blow molds and methods of use for producing molded parts having reduced flash.

### BACKGROUND OF THE INVENTION

Plastic molding is a process used to form substances into desired shapes. Typically, a plastic substance in a fluid state is positioned in a mold by gravity or mechanical force. Most molds consist of two or more conjoined blocks, which are separated after the substance has solidified. The finished part is removed from the mold and the molding process is repeated. Certain post-mold process steps may be taken to finish the part.

Plastics may be molded using a variety of processes including blow molding, injection molding, compression molding, transfer molding, rotational molding and extrusion. Blow molding is a bulging process in which a tubular piece of plastic is heated and internally pressurized. The internal pressure causes the plastic to expand within a cavity of a pre-formed mold such that the plastic takes on the shape of the cavity. Products made from blow molding are typically hollow, thin-walled containers or articles, such as for example, two liter beverage containers, children's toys or household items.

One possible result of typical molding processes is the by-product of flash. Flash is a thin layer of material that forms within gaps or seams between components of a mold, such as between mold blocks. Flash from a flash seam can be removed from finished parts, often in a subsequent manufacturing operation. Flash seams may not be desirable in ornamental molded products. Flash seams visible in conspicuous locations on an ornamental molded product may be particularly undesirable.

Using conventional molds, control of the amount of flash at a flash seam can be difficult depending upon the shape of the molded part and correspondingly, the shape of the interior surface of the mold blocks. Therefore, a need exists in the art for a blow mold for apparatus and methods that produces reduced flash at flash seams.

### SUMMARY OF THE INVENTION

A mold and process for use of the mold in forming a molded part having limited flash when a flash seam is disposed in an inconspicuous location is disclosed.

The mold includes a first mold block having a first contact surface and a first shear surface; a second mold block having a second contact surface and an insert seating surface; and at least one removable insert having a second shear surface and positionable along the insert seating surface. The first mold block is separable from and engageable with the second mold block between open and closed positions of the mold. The mold is moved between open and closed positions by the movement of at least one of the mold blocks along a path of travel. When the mold is moved from an open to a closed position, the first shear surface and the second shear surface form an interference fit. Brief Description of the Drawings

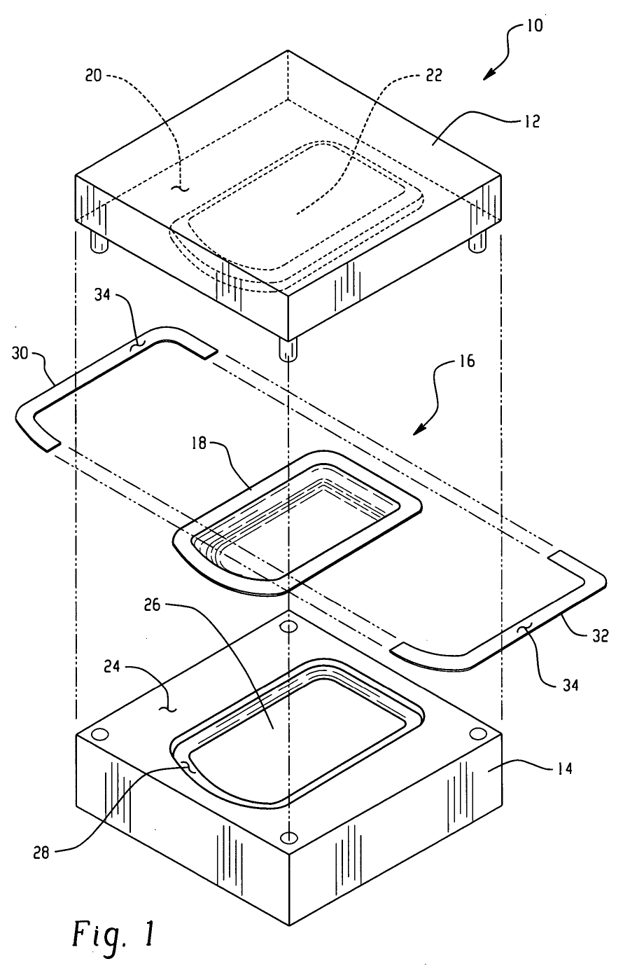

FIG. 1 is a perspective view of a blow mold including an insert assembly;

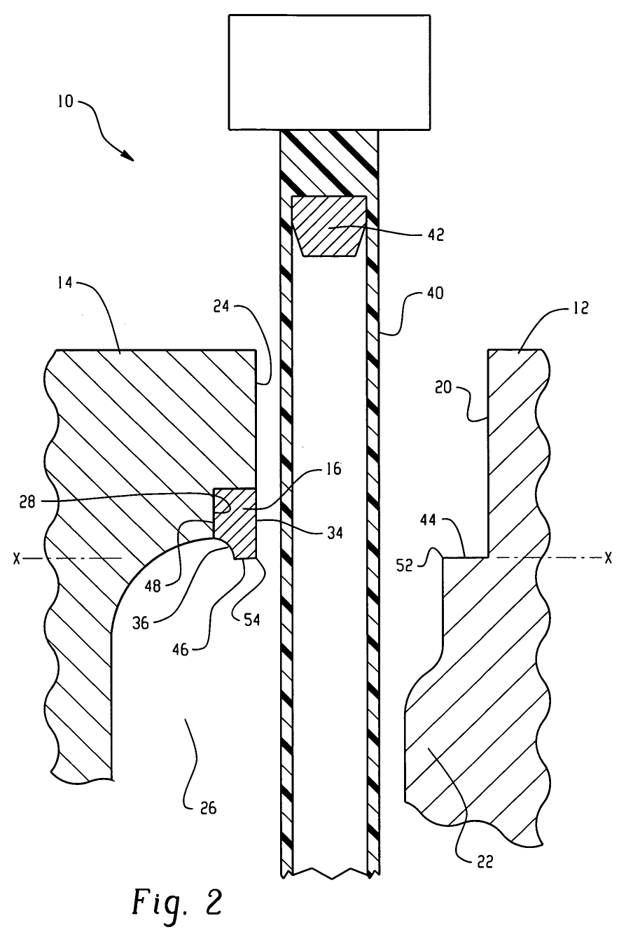

FIG. 2 is a cross-sectional fragmentary view of a blow mold including an insert assembly shear surface arranged in accordance with one embodiment of the present invention, showing the mold in an open position;

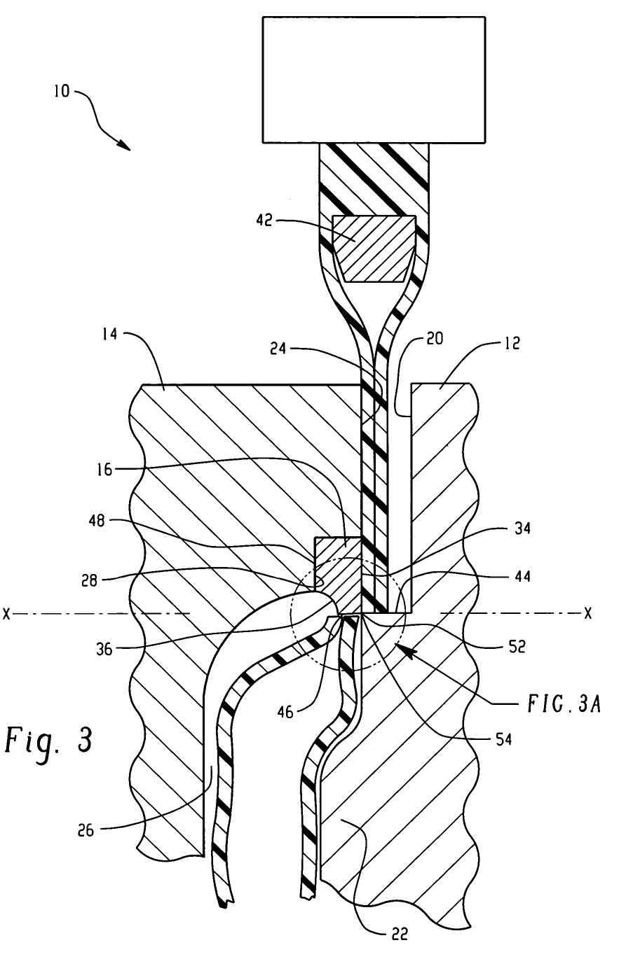

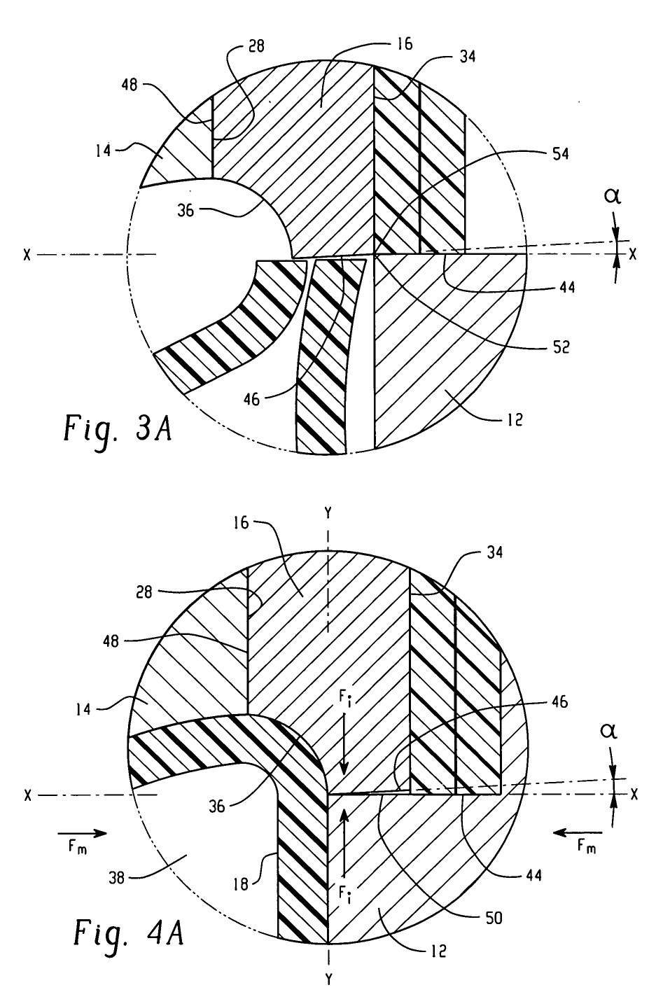

FIG. 3 is a cross-sectional fragmentary view of the blow mold of FIG. 2, showing the mold in a partially closed position;

FIG. 3A is a detailed view of the insert assembly shear surface of the blow mold of FIG. 2, showing the mold in a partially closed position;

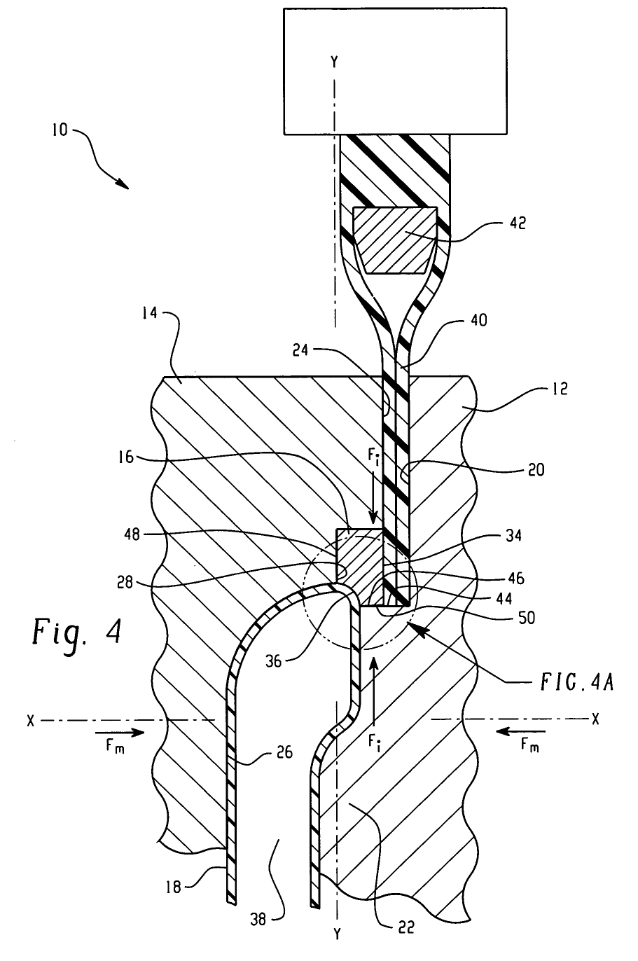

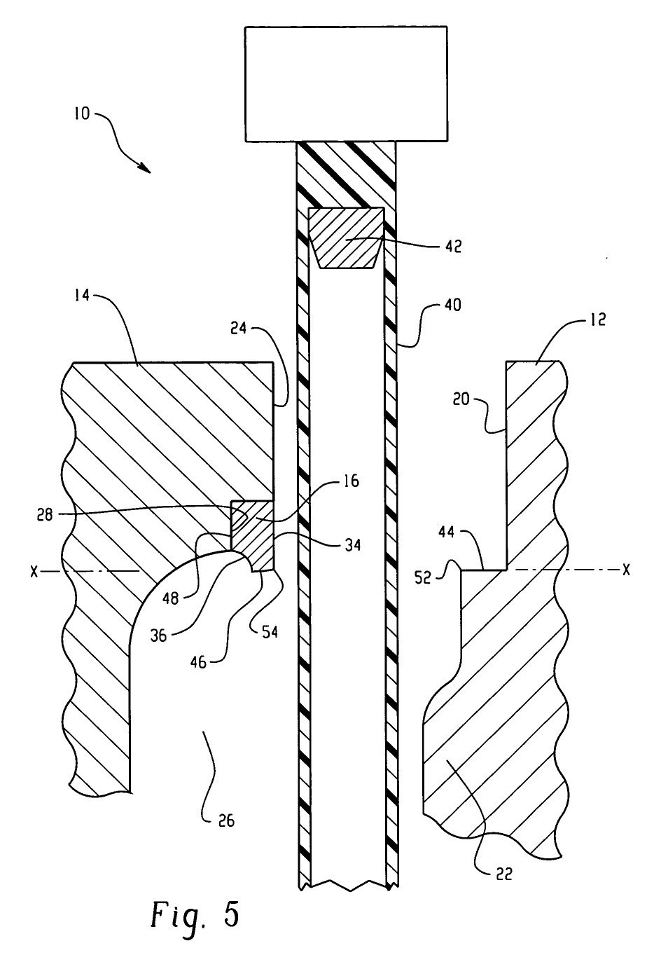

FIG. 4 is a cross-sectional fragmentary view of the blow mold of FIG. 2, showing the mold in a closed position;

FIG. 4A is a detailed view of the insert assembly shear surface of the blow mold of FIG. 2, showing the mold in a closed position;

FIG. 5 is a cross-sectional fragmentary view of a blow mold including an alternative insert assembly shear surface arranged in accordance with another embodiment of the present invention, showing the mold in an open position;

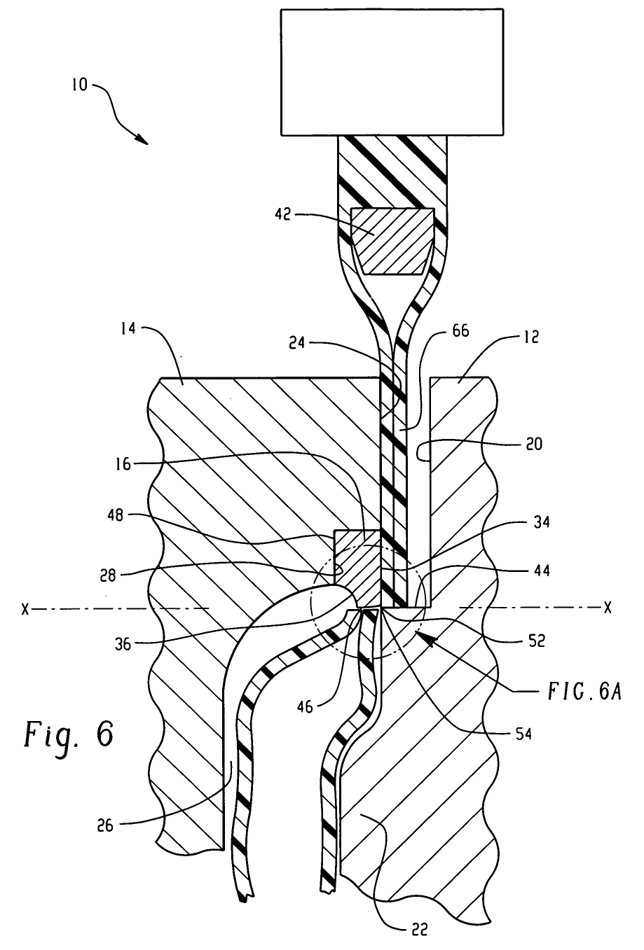

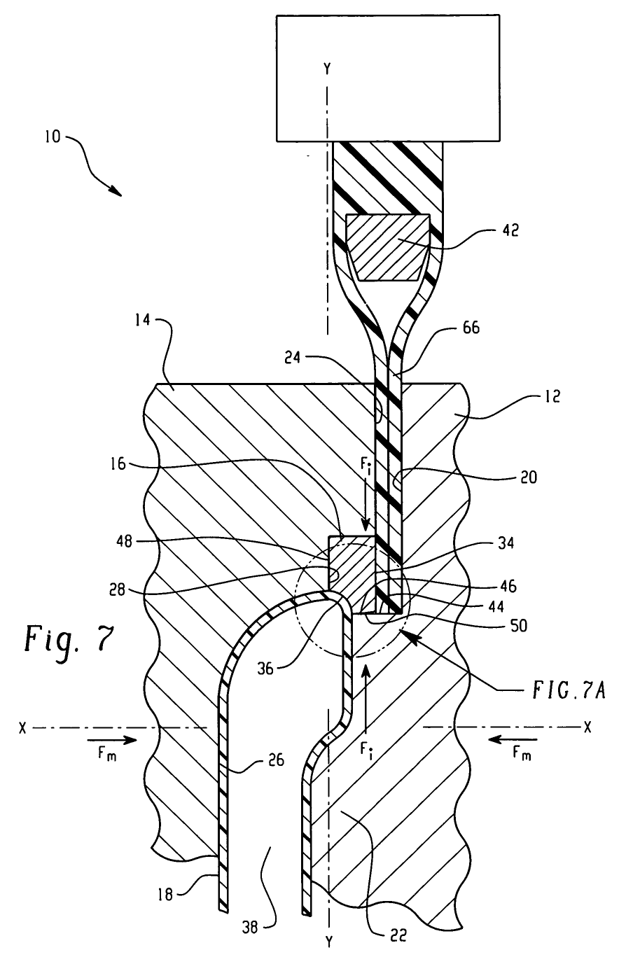

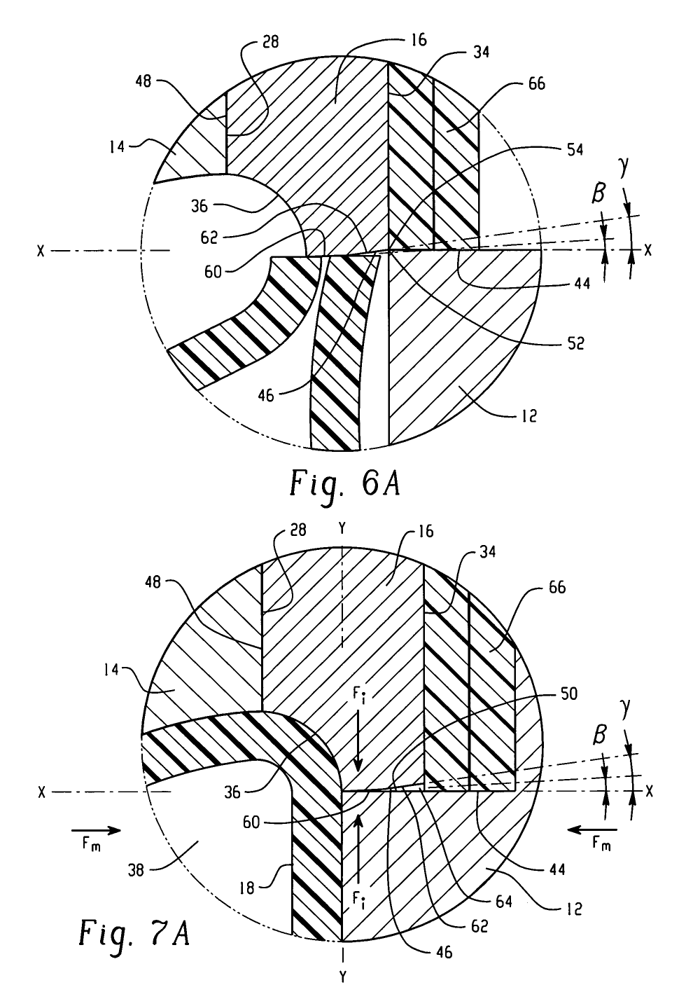

FIG. 6 is a cross-sectional fragmentary view of the blow mold of FIG. 5, showing the mold in a partially closed position;

FIG. 6A is a detailed view of the insert assembly shear surface of the blow mold of FIG. 5, showing the mold in a partially closed position;

FIG. 7 is a cross-sectional fragmentary view of the blow mold of FIG. 5, showing the mold in a closed position;

FIG. 7A is a detailed view of the insert assembly shear surface of the blow mold of FIG. 5, showing the mold in a closed position;

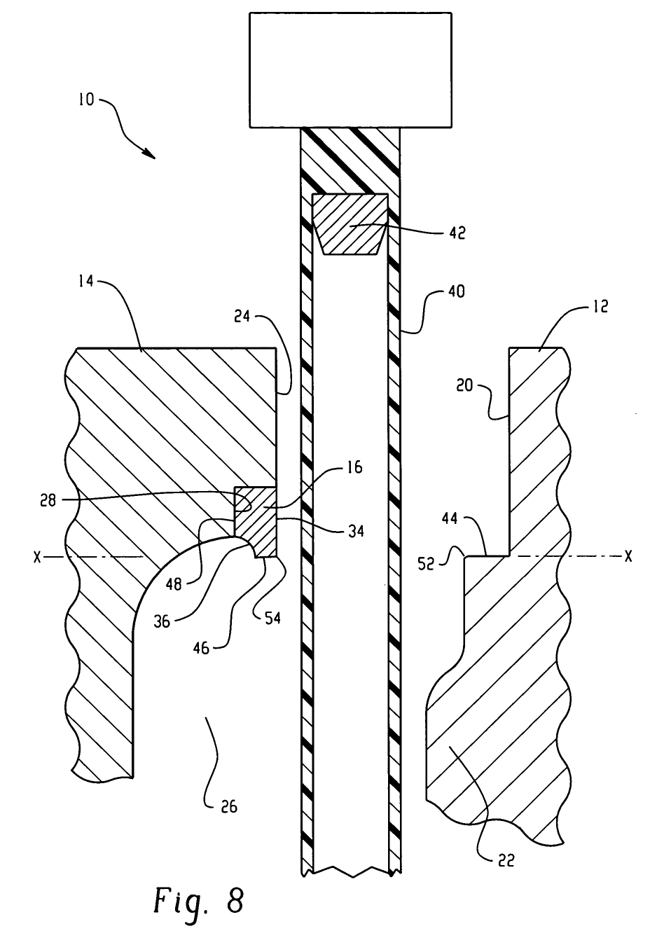

FIG. 8 is a cross-sectional fragmentary view of a blow mold including an alternative insert assembly shear surface arranged in accordance with yet another embodiment of the present invention, showing the mold in an open position;

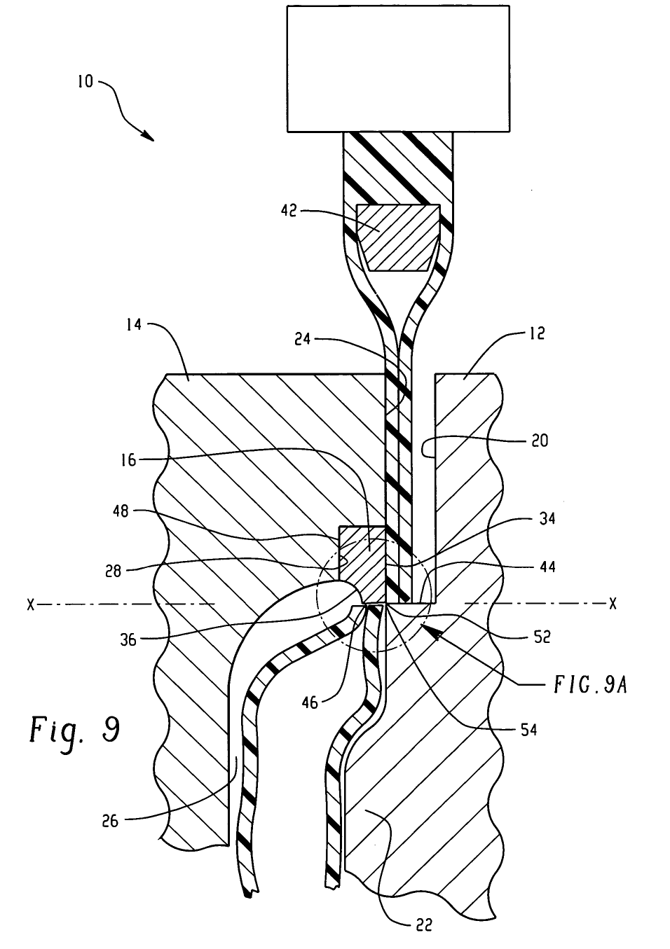

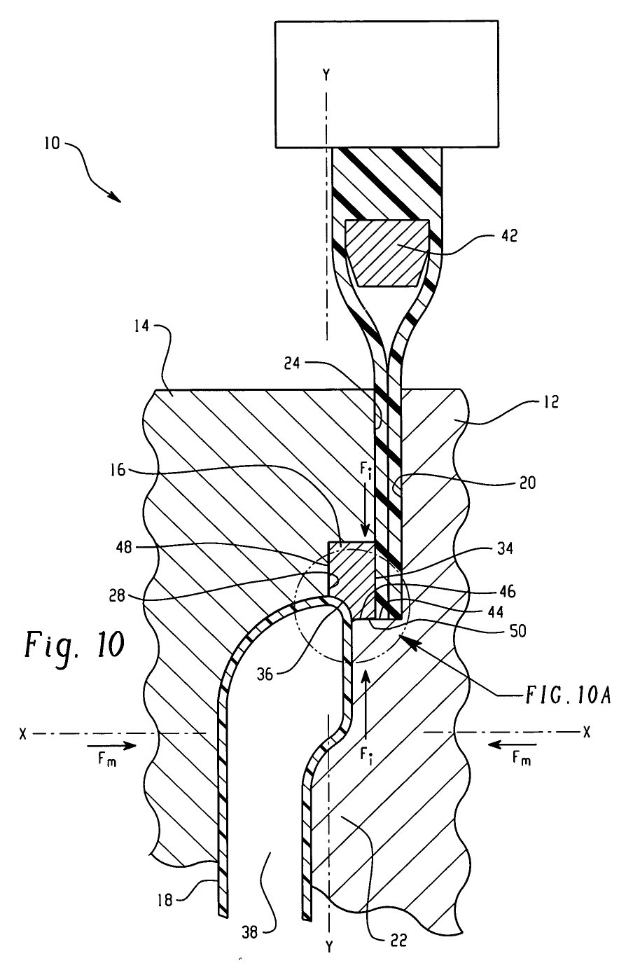

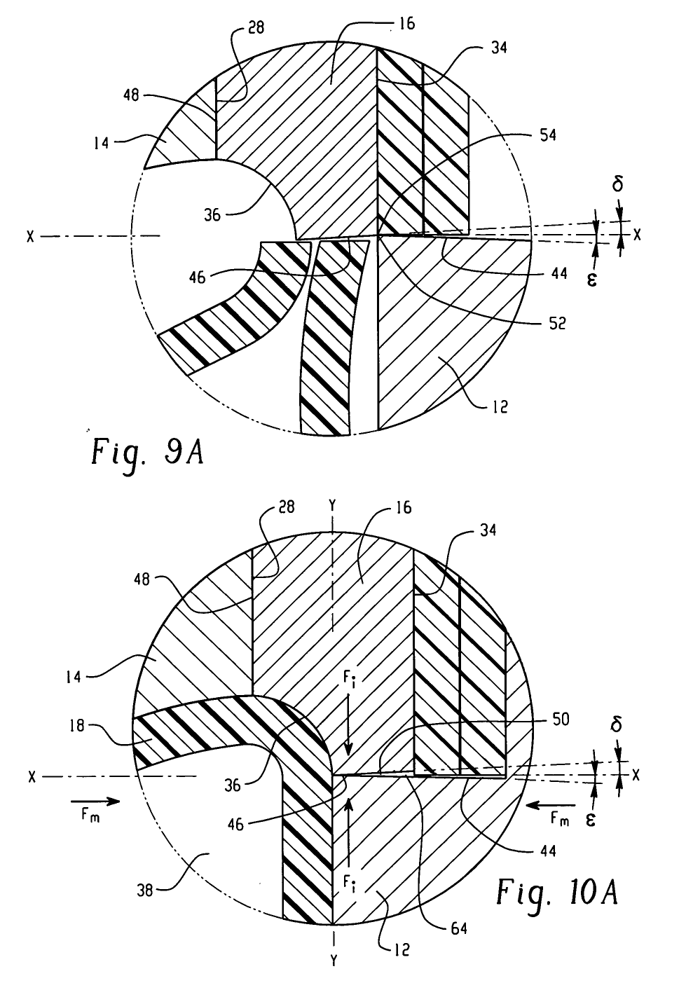

FIG. 9 is a cross-sectional fragmentary view of the blow mold of FIG. 8, showing the mold in a partially closed position;

FIG. 9A is a detailed view of the insert assembly shear surface of the blow mold of FIG. 8, showing the mold in a partially closed position;

FIG. 10 is a cross-sectional fragmentary view of the blow mold of FIG. 8, showing the mold in a closed position;

FIG. 10A is a detailed view of the insert assembly shear surface of the blow mold of FIG. 8, showing the mold in a closed position; and

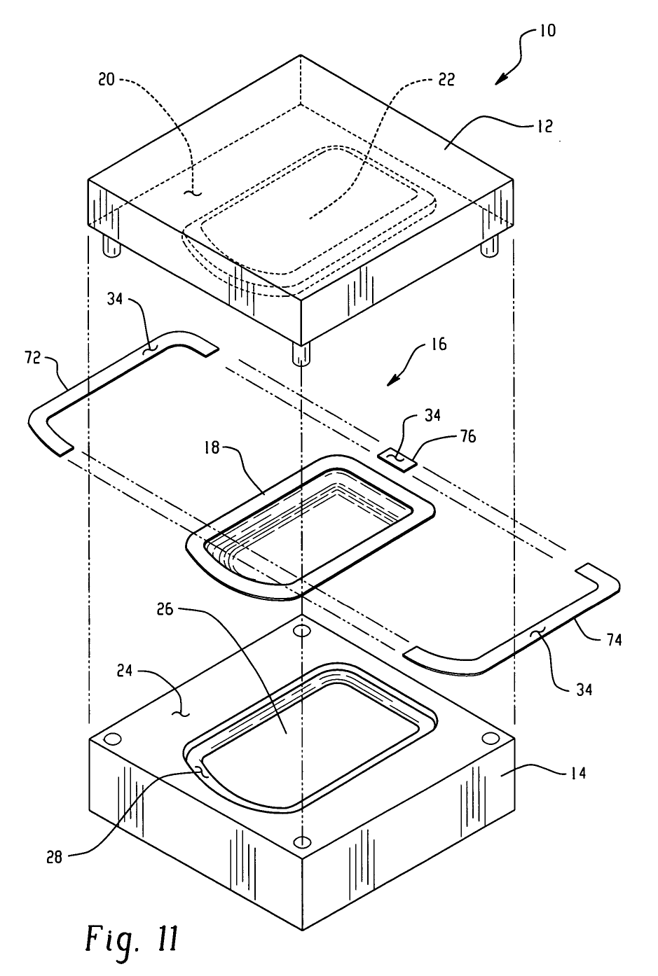

FIG. 11 is a perspective view of a blow mold with an alternative insert assembly made in accordance with this invention.

### DETAILED DESCRIPTION OF THE INVENTION

The Detailed Description of the Invention merely describes preferred embodiments of the invention and is not intended to limit the scope of the claims in any way. Indeed, the invention as described by the claims is broader than and unlimited by the preferred embodiments, and the terms in the claims have their full ordinary meaning.

The Figures and Detailed Description of the Invention illustrate embodiments of a removeable insert used in a molding process. While the descriptions and illustrations are directed to blow molding, the features of the present invention could be applied to other molding techniques, such as for example, twin sheet vacuuming forming, standard vacuum forming, thermoforming, injection molding, compression molding, transfer molding, rotational molding, and extrusion.

FIG. 1 shows a perspective view of a typical blow mold that includes an insert assembly. The blow mold 10 includes a first mold block 12, a second mold block 14, and a removable insert assembly 16. The pair of mold blocks 12 and 14 and the insert assembly are arranged such that when the blow mold 10 is closed, a cavity is formed in which a molded part 18 may be formed by a blow molding process. The insert assembly 16 can be utilized to move a flash seam from a conspicuous location to an inconspicuous location. An example of such a blow mold and processes of using such a blow mold is shown and described in U.S. Pat. No. 6,659,750 to Overmyer et al., which is hereby incorporated by reference in its entirety.

The first mold block 12 includes a first contact surface 20 and a raised area 22 along the first contact surface 20. The second mold block 14 includes a second contact surface 24, a recessed chamber 26 along the second contact surface 24, and an insert seating surface 28. The insert seating surface 28 is arranged such that the insert assembly 16 can be seated along this surface 28. In the embodiment illustrated in FIG. 1, the insert assembly 16 includes a first member 30 and a second member 32 that can be arranged to form a continuous ring. When the insert assembly 16 is seated along the insert seating surface 28 of the second block 14, a surface 34 of the insert assembly 16 is exposed. This exposed surface 34 is positioned to be generally at the same level as the second contact surface 24 and forms an extension of the second contact surface 24, as will be further described.

The molded part 18 is formed by a process that includes positioning plastic or other moldable material between the first 12 and second 14 mold blocks. The mold 10 is then closed by pressing the mold blocks 12 and 14 together such that the contact surface 20 of the first block 12 comes into contact with the contract surface 24 of the second mold block 14 and the exposed surface 34 of the insert assembly 16 that is seated within the second mold block 14. In this arrangement, the raised area 22 of the first mold block 12, the recessed chamber 26 of the second mold block 14, and a cavity portion 36 of the insert assembly 16 form a mold cavity 38 (as best seen in FIG. 4). Once the plastic is positioned within the cavity 38 of the closed mold 10, the plastic is internally pressurized and expands within the cavity 38 to form the molded part 18. The contours of the raised area 22, the recessed chamber 26, and the cavity portion 36 of the insert assembly 16 are determined by the shape and size of the desired molded part 18.

Referring to FIGS. 2, 3, 3A, 4, and 4A, one embodiment of an insert assembly is shown. Typically, a raw material parison 40 is positioned between the first and second mold blocks 12 and 14 when the mold is in the open position. Examples of methods of positioning the parison 40 include the use of mechanical force or the force of gravity. As shown in FIG. 2, a plastic parison 40 is formed by extruding molten polymer from an extrusion die head 42 to form a hollow tube of plastic. The parison 40 is positioned between the first and second mold blocks 12 and 14 by gravitational force.

The first mold block 12 is separable and engageable with the second mold block 14 between open and closed positions. Preferably, the first mold block 12 travels along a horizontal axis X to open and close the mold 10. Although the first block 12 is described as moving along a horizontal axis X, it should be appreciated by those skilled in the art that either or both the first or second block 12 and 14 can move along the horizontal axis X. In addition, the path of travel does not need to be horizontal; the path of travel can be vertical or positioned at any angle or along any plane.

As shown in FIG. 3, once the parison 40 is positioned between the first 12 and second 14 mold blocks, the molding process can be initiated by moving the first mold block 12 towards the second mold block 14 to closing the mold 10. The first mold block 12 includes a shear surface 44 and the insert assembly 16 includes a shear surface 46. As the first mold block 12 is moved horizontally to close the mold 10 the parison 40 is cut by the interaction of the first mold block shear surface 44 and the insert assembly shear surface 46. This process positions the appropriate amount of parison 40 inside the mold cavity 38 to accommodate the blow molding process.

As shown in FIG. 4, once the mold 10 is closed, the blow molding process can be used to form the molded part 18. Typically, the internal pressure of the blow molding process needed to form the part 18 encourages portions of the plastic material into seams formed between mold components. This can often lead to flash seams forming. The mold 10 shown in FIG. 4 includes two seams. There is a first seam 48 formed at the interface of the second molding block insert seating surface 28 and the insert assembly 16. A second seam 50 is formed at the interface of the first mold block shear surface 44 and the insert assembly shear surface 46. The first seam 48 is generally transverse, to the path of travel X of the first mold block 12. The second seam 50 is generally inline with the path of travel X of the first mold block 12. The differing orientations of these seams 48 and 50 cause flash to develop differently in the first 48 and second 50 seams.

The mold blocks 12 and 14 are pressed together by a molding force Fₘ applied along the axis of travel X. This force Fₘ is generally high enough to resist the internal pressurization of the mold cavity 38 during the molding process. The molding force Fₘ is transferred to the interface of the first mold block insert seating surface 28 and insert assembly 16, which is located at the first seam 48. The application of the molding force Fₘ at the first seam 48 serves to force the mold components together and resist flash from entering the seam 48. This is generally the case for seams that are generally perpendicular, or otherwise transverse, to the direction in which the molding force Fₘ is applied. The second seam 50, however, is inline with the path of travel X and the direction of the molding force Fₘ, and thus, does not gain substantial flash resistant benefits from the molding force Fₘ. Generally, seams that are generally parallel, or otherwise inline, with the path of travel X and the direction of the molding force Fₘ do not benefit from the molding force Fₘ pressing mold components together and may be susceptible to flash. However, there are arrangements that can be developed for these generally inline seams to resist flash.

As best shown in FIGS. 3A and 4A, the insert assembly shear surface 46 is arranged at an angle α, relative to the path of travel X of the first mold block 12. The shear surface 44 of the first mold block 14 is generally parallel or inline with the path of travel X of the first mold block 12. As the first mold block 12 travels towards the second mold block 14, a leading edge 52 of the first mold block shear surface 44 moves towards the insert assembly shear surface 46. As the leading edge 52 nears the insert assembly shear surface 46, the parison 40 is cut or sheared by the interaction of the shear surfaces 44 and 46. The leading edge 52 of first mold block shear surface 44 and the insert assembly shear surface 46 are arranged such that as the first mold block 12 approaches a distal edge 54 of the insert assembly 16 (as best seen in FIG. 3A) sufficient clearance exists for the leading edge 52 to move pass the distal edge 54 of the insert assembly. However, due to the angle α of the insert assembly shear surface 46, the leading edge 52 of the first mold block shear surface 44 encounters the insert assembly shear surface 46 soon after the leading edge 52 passes the distal edge 54. The contact of the leading edge 52 to the angled insert assembly shear surface 46 creates an interference fit between the insert assembly 16 and the first mold block 12. As the mold 10 continues to close, the interference fit becomes greater.

The interference fit is greatest when the mold 10 is fully closed, as shown in FIGS. 4 and 4A. This interference fit creates a force Fᵢ along an axis Y that is generally perpendicular to the axis of travel X. This force Fᵢ serves to resist flash along the second seam 50 between the insert assembly shear surface 46 and the first mold block shear surface 44 during the blow molding process. In one exemplary embodiment, the angle α of the insert assembly shear surface 46 relative to the path of travel X of the mold 10 is approximately 3 degrees.

The leading edge 52 of the first mold block shear surface 44 can be beveled or otherwise rounded. Rounding the leading edge 52 lessen the opportunity for the leading edge 52 to dig into or otherwise damage the insert assembly shear surface 46 as the leading edge 52 slides along the insert assembly shear surface 46 as the mold 10 moves from an open to a closed position.

Although the exemplary embodiment describes the angle α of the insert assembly shear surface 46 as 3 degrees, it should be understood that any angle that allows the leading edge 52 of the first mold block shear surface 44 to pass by the distal edge 54 of the insert assembly shear surface 46, while creating a force Fᵢ generally perpendicular to the interface between the first mold block shear surface 44 and the insert assembly shear surface 46 to resist flash entering the seam 50, is included in this description of the invention.

FIGS. 5, 6, 6A, 7, and 7A illustrate another embodiment of the insert assembly 16. In this embodiment, the insert assembly shear surface 46 includes a first surface portion 60 and a second surface portion 62. The first surface portion 60 is non-planar with respect to the second surface portion 62. As best seen in FIGS. 6A and 7A, the first surface portion 60 is arranged at an angle β relative to the path of travel X and the second surface portion 62 is arranged at a different angle γ relative to the path of travel X. The angle γ of the second surface portion 62 is generally greater than the angle β of the first surface portion 60. The addition of a second surface potion 62 creates a larger void 64 between the first mold block shear surface 44 and the insert assembly shear surface 46 when the mold 10 is closed (as best seen in FIG. 7A). As the mold blocks 12 and 14 are pressed together, the portion 66 of the parison 40 cut or trimmed from the parison 40 and not in the mold cavity 38 is trapped between the mold blocks 12 and 14 and is subject to pressure (as best seen in FIG. 7A). The void 64 created by the addition of a second surface portion 62 can serve as a relief for excess parison material 66 that is subject to this pressure. In an exemplary embodiment, angle β of the first surface portion 60 is approximately 3 degrees and the angle γ of the second surface portion 62 is approximately 8 degrees. Although values for angles β and γ are given in an exemplary embodiment, it should be understood that any value for the angles β and γ that achieve an enhanced void to serve as a relief for excess parison material under pressure is included in this description of the invention.

FIGS. 8, 9, 9A, 10, and 10A illustrate another embodiment of the insert assembly 16 and first mold block 12. In this embodiment the insert assembly shear surface 46 is arranged at an angle δ with respect to the path of travel X, similarly to that shown in FIGS. 3 and 3A. However, the shear surface 44 of the first mold block is also arranged at an angle ε with respect to the path of travel X. Generally, the angle δ of the insert assembly shear surface 46 is angled upwards (with respect to the horizontal path of travel X) and the angle ε of the first mold block shear surface 44 is angled downwards (with respect to the horizontal path of travel X). This arrangement can lead to a larger void 64 between the insert assembly shear surface 46 and the shear surface 44 of the first mold block 12 when the mold 10 is closed. In addition, this arrangement may allow for a smoother closing of the mold 10 when the leading edge 52 of the first mold block shear surface 44 slides along the insert assembly shear surface 46 during the closing of the mold 10.

FIG. 11 illustrates an alternative embodiment of the insert assembly 16. In this embodiment, the insert assembly 16 includes three insert members 70, 72, and 74. The number of members included in the insert assembly 16 is determined, at least in part, by the size, shape, and complexity of the molded part 18. For example, a given molded part may have multiple versions with one design detail distinguishing the versions. Under these circumstances, the design detail may be determined by one of the insert members. Referring to FIG. 11, the molded part 18 may be a lid and the insert member 76 may determine the type of hinge that can be fitted to the part 18. Under these conditions, only insert member 76 would need to be changed in order to produce parts that can accommodate different hinges.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A mold for use in forming a molded part comprising:
a) a first mold block comprising:
i) a first contact surface and
ii) a first shear surface;
b) a second mold block, separable from and engageable with the first mold block between open and closed positions, comprising:
i) a second contact surface; and
ii) an insert seating surface; and
c) at least one removable insert positionable along the insert seating surface and including a second shear surface;
wherein the mold is moveable between open and closed positions by movement of at least one mold block along a path of travel;
wherein the first shear surface and the second shear surface form an interference fit when the mold is moved into the closed position.

2. The mold of claim 1, wherein the insert is comprised of a first insert member and a second insert member.

3. The mold of claim 2, wherein the insert is further comprised of a third insert member.

4. The mold of claim 1, wherein the second shear surface is arranged at an angle with respect to the path of travel of the at least one mold block.

5. The mold of claim 4, wherein the first mold surface is arranged at an angle with respect to the path of travel of the at least one mold block.

6. The mold of claim 4, wherein the angle with respect to the path of travel of the at least one mold block is approximately 3 degrees.

7. The mold of claim 4, wherein the first shear surface includes a leading edge.

8. The mold of claim 7, wherein the leading edge of the first shear surface is rounded.

9. The mold of claim 1, wherein the first shear surface includes a first surface portion and a second surface portion, wherein the first surface portion is non-planar with respect to the second surface portion.

10. The mold of claim 9, wherein the first surface portion is arranged at a first angle with respect to the path of travel of the at least one mold block and the second surface portion is arranged at a second angle with respect to the path of travel of the at least one mold block.

11. The mold of claim 10, wherein the first angle is approximately 3 degrees and the second angle is approximately 8 degrees.

12. The mold of claim 9, wherein the first surface portion is least 3 degrees from planar with respect to second surface portion.

13. The mold of claim 1, wherein the first shear surface and the second shear surface form an increasing interference fit as the mold progressively moves from an open position to a closed position.

14. The mold of claim 1 wherein:
a) the first mold block further includes a raised portion;
b) the second mold block further includes a recessed portion; and
c) the insert further includes a cavity portion;
wherein when the mold is in a closed position, the raised portion, the recessed portion, and the cavity portion form a mold cavity in which the molded part is formed.

15. The mold of claim 1, wherein when the mold is in the closed position, the first contact surface is contiguous with the second contact surface.

16. A method of blow molding comprising:
a) providing a mold for use in forming a molded part, the mold comprising:
i) a first mold block having a first contact surface and a first shear surface;
ii) a second mold block, separable from and engageable with the first mold block between open and closed positions, having a second contact surface and an insert seating surface; and
iii) at least one removable insert positionable along the insert seating surface and having a second shear surface;
b) positioning a section of parison within a space between the first mold block and the second mold block when the mold is in the open position;
c) moving at least one mold block along a path of travel to close the mold;
d) shearing the parison by an interaction of the first shear surface and the second shear surface;
e) forming an interference fit between the first shear surface and the second shear surface by arranging the second shear surface at a first angle with respect to the path of travel of the at least one mold block; and
f) expanding the parison to form the molded part.

17. The method of claim 16, wherein the second shearing surface includes a first surface portion and a second surface portion;
wherein the first surface portion is arranged at a second angle with respect to the path of travel of the at least one mold block and the second surface portion is arranged at a third angle with respect to the path of travel of the at least one mold block.

18. The method of claim 16 further comprising the step of arranging the first shear surface at a fourth angle with respect to the path of travel of the at least one mold block.

19. The method of claim 16 further comprising the step of forming a void between the first shear surface and the second shear surface as the at least one mold block moves along the path of travel to close the mold.

20. A mold for use in forming a molded part comprising:
a) a first mold half comprising:
i) a first contact surface and
ii) a first shear surface;
b) a second mold half comprising:
i) a second contact surface; and
ii) an insert seating surface; and
c) at least one removable insert positionable along the insert seating surface and including a second shear surface;
wherein the first shear surface is positioned at an angle relative to the second shear surface.
